(19) United States
(12) Patent Application Publication
(10) Pub. No.: US 2026/0334556 A1
(43) Pub. Date: Oct. 29, 2026

(54) AEROSOL GENERATING DEVICE

(71) Applicant: KT&G CORPORATION, Daejeon (KR)

(72) Inventors: Jae Min LEE, Siheung-si (KR); Sang Kyu PARK, Seoul (KR); Se Hwan JUNG, Anyang-si (KR)

(73) Assignee: KT&G CORPORATION, Daejeon (KR)

(21) Appl. No.: 19/732,732

(22) Filed: Jul. 7, 2026

Related U.S. Application Data
(63) Continuation of application No. 19/277,920, filed on Jul. 23, 2025.

(30) Foreign Application Priority Data
Jul. 24, 2024 (KR) 10-2024-0097586

(51) Int. Cl. A24F 40/46; A24F 40/20; A24F 40/57; H05B 3/46

(52) U.S. Cl. CPC A24F 40/46; A24F 40/20; A24F 40/57; H05B 3/46; H05B 2203/032

(57) ABSTRACT

An aerosol generating device is disclosed. The aerosol generating device according to various embodiments of the present invention includes: a body including an insertion space open to allow insertion of at least a part of a stick; an infrared radiator formed in at least a partial area of the insertion space so as to be in contact with or close to at least a part of the stick; a heating element formed to be in contact with or close to at least a part of the infrared radiator to conduct heat to the infrared radiator; and a control unit configured to apply a power source to the heating element.

### CROSS-REFERENCE TO RELATED APPLICATION

This application is a continuation of U.S. Application No. 19/277,920 filed on Jul. 23, 2025, which claims priority to Korean Patent Application No. 10-2024-0097586 filed on Jul. 24, 2024, the disclosures of which are incorporated herein by reference in their entirety.

### FIELD OF TECHNOLOGY

Various embodiments of the present invention relate to an aerosol generating device capable of heating a stick more efficiently.

### BACKGROUND

Aerosol forming devices typically heat a stick in a resistive or inductive manner to form an aerosol.

In recent years, methods utilizing infrared wavelengths have been disclosed to increase the efficiency of heat transfer to sticks. For example, an infrared ray is radiated by directly applying a power source to an infrared radiator material such as carbon nanotubes, and the radiated infrared ray heats a stick.

However, since such an infrared radiator has too high conductivity, there is a problem that heat is instantaneously splashed when power is directly applied, and thus heat generation control is difficult.

### SUMMARY

The technical problem to be achieved by the present invention has been devised in order to solve the above-described problems, and an object of the present invention is to heat an infrared radiator in such a manner that the infrared radiator is heat-conducted by a heating element in contact with or adjacent to the infrared radiator without applying a separate power supply to the infrared radiator, and to radiate infrared rays from the heated infrared radiator.

The problems to be solved by the present invention are not limited to the problems mentioned above, and other problems not mentioned will be clearly understood by a person skilled in the art from the following description.

According to one or more example implementations of the present disclosure, an aerosol generating device according to various embodiments of the present invention includes: a body including an insertion space opened to allow insertion of at least a part of a stick; an infrared radiator formed in at least a partial region of the insertion space so as to be in contact with or close to at least a part of the stick; a heating element formed to be in contact with or close to at least a part of the infrared radiator to conduct heat to the infrared radiator; and a control unit configured to apply a power source to the heating element.

In some embodiments, the infrared radiator may be heated only through the heating element.

In some embodiments, the infrared radiator may be formed to wrap around the stick, and the heating element may be formed to wrap around the infrared radiator.

In some embodiments, the stick may be cylindrical, and the infrared radiator and the heating element may be configured in the form of a tube including a hollow, wherein the infrared radiator, based on the midpoint of the stick, may have a greater diameter than the stick, and the heating element may have a greater diameter than the infrared radiator.

In some embodiments, the aerosol generating device may further include a coating layer that wraps inward around the stick, contacts the infrared radiator outwardly, and having a transparency greater than or equal to a predetermined value.

In some embodiments, the aerosol generating device may further include an adhesive layer that wraps inward around the infrared radiator, contacts the heating element outwardly, and bonds the infrared radiator and the heating element.

In some embodiments, at least one of the infrared radiator and the heating element may be configured as a detachable module to be detachable from the aerosol generating device.

In some embodiments, the control unit may be configured to: check a temperature of at least one of the stick, the infrared radiator, and the heating element, and control the power source applied to the heating element based on the checked temperature.

In some embodiments, the control unit may be configured to: increase an amount of current applied to the heating element when the checked temperature is less than or equal to a first preset threshold value.

In some embodiments, the control unit may be configured to: reduce an amount of current applied to the heating element when the checked temperature is equal to or higher than the preset second threshold value, and wherein the second threshold value may be set to a value higher than the first threshold value.

According to an embodiment of the present disclosure, an infrared radiator is heated in such a manner that the infrared radiator is heat-conducted by a heating element adjacent to the infrared radiator without applying a separate power supply to the infrared radiator, so that there is an advantage in that heat generation may be controlled by radiating infrared rays more stably.

The effects of the present invention are not limited to the effects mentioned above, and other effects not mentioned will be clearly understood by a person skilled in the art from the following description.

### BRIEF DESCRIPTION OF THE DRAWINGS

FIG. 1 is a diagram illustrating an aerosol generating device according to an embodiment of the present disclosure.

FIG. 2 is a diagram illustrating an aerosol generating device according to another embodiment of the present disclosure.

FIG. 3 is a diagram illustrating a stick heating structure according to an embodiment of the present disclosure.

FIG. 4 is a diagram illustrating an aerosol generating device including a stick heating structure according to another embodiment of the present disclosure.

FIG. 5 is a cross-sectional view of the stick heating structure of FIG. 4.

FIG. 6 is a flowchart illustrating temperature feedback control according to an embodiment of the present disclosure.

FIG. 7 is a front perspective view of an aerosol generating device according to embodiments of the present disclosure.

### DETAILED DESCRIPTION

Hereinafter, preferred embodiments of the present invention will be described in detail with reference to the accompanying drawings.

However, the technical idea of the present invention is not limited to some embodiments described, but may be implemented in various forms different from each other, and one or more of the components may be selectively combined or substituted between embodiments within the scope of the technical idea of this invention.

In addition, terms (including technical and scientific terms) used in the embodiments of the present invention may be interpreted in a meaning that may be generally understood by a person skilled in the art to which the present invention belongs, unless expressly defined and described in detail, and terms that are generally used, such as terms defined in advance, may be interpreted in consideration of the meaning in the context of the related art.

In addition, the terminology used in the embodiments of the present invention is for the purpose of describing the embodiments and is not intended to limit the present invention.

As used herein, the singular forms “a”, “an”, and “the” may include plural forms as well, unless otherwise specified in the context, and may include one or more of all combinations that may be combined into “A”, “B”, and “C” when described as “at least one (or one or more) of A and (as well as) B and C”.

In the description of the components of the embodiments of the present invention, the terms “first”, “second”, “A”, “B”, “ (a)”, “ (b)”, and the like may be used.

These terms are only used to distinguish the components from other components, and are not limited by the terms to the nature, sequence, or order of the components.

In addition, when a component is described as being “connected,” “coupled,” or “accesses” to another component, the component may be directly connected, coupled, or accessed to the other component, as well as being “connected”, “coupled”, or “connected” due to another component between the component and the other component.

Also, when described as being formed or disposed “up (upper)” or “down (lower)” each component, top of or under includes not only when two components are in direct contact with each other, but also when one or more other components are formed or disposed between the two components. In addition, when it is expressed as “up (upper) or down (lower)”, it may include not only an upward direction but also a downward direction with respect to one component.

Hereinafter, embodiments will be described in detail with reference to the accompanying drawings, and the same or corresponding components will be denoted by the same reference numerals regardless of the drawing symbols, and redundant description thereof will be omitted.

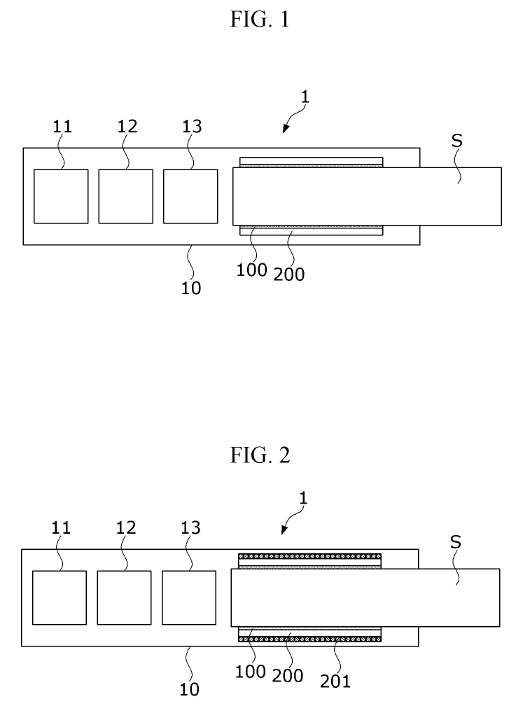

FIGS. 1-2 illustrate an aerosol generating device 1 according to various embodiments of the present disclosure.

Referring to FIG. 1, the aerosol generating device 1 according to embodiments of the present disclosure may include at least one of a power source 11, a control unit 12, a sensor 13, an infrared radiator 100, and a heating element 200. At least one of the power source 11, the control unit 12, the sensor 13, the infrared radiator 100, and the heating element 200 may be disposed inside a body 10 of the aerosol generating device 1. The body 10 may provide an upwardly opened space for insertion of a stick S, which is an aerosol-generating article. The upwardly opened space may be referred to as an insertion space. The insertion space may be formed to be recessed by a predetermined depth toward the inside of the body 10 so that at least a part of the stick S may be inserted. The depth of the insertion space may correspond to the length of the area in which the aerosol generating material and/or the medium is contained in the stick S. A lower end of the stick S may be inserted into the body 10, and an upper end of the stick S may protrude to the outside of the body 10. A user may suck the air with the upper end of the stick S exposed to the outside in his/her mouth.

At least one of the infrared radiator 100 and the heating element 200 may heat the stick S. The infrared radiator 100 and the heating element 200 may extend upwardly in a space into which the stick S is inserted. For example, the stick S may be cylindrical, and the infrared radiator 100 and the heating element 200 may be in the form of a tube including a hollow therein. The infrared radiator 100 and the heating element 200 may be disposed around the insertion space. The infrared radiator 100 may be formed in at least a partial area of the insertion space so as to be in contact with or close to at least a part of the stick S.

The infrared radiator 100 may emit an infrared wavelength to heat the stick S. According to various embodiments, the infrared radiator 100 may be a carbon-based material such as a carbon nanotube, a ceramic, a metal having high emissivity and heat resistance, or the like, but is not limited thereto. The infrared radiator 100 heat the stick by radiating infrared waves into the inside of the tobacco stick and vibrating the medium of the stick composition. The infrared radiator 100 may have a thickness of 1 mm or less, but is not limited thereto.

According to an embodiment, the infrared radiator 100 may be heated only by the heating element 200. That is, a heat source may be supplied only through the heating element 200 without a separate power source being applied to the infrared radiator 100 itself. To this end, the infrared radiator 100 may be formed so as to be in direct physical contact with or adjacent to the heating element 200 without a separate power source connection. The infrared radiator 100 may be heated in direct contact with the heating element 200 or through a predetermined intermediate layer. The heat generated in the heating element 200 may heat the infrared radiator 100 to a predetermined temperature (e.g., 150 to 400 degrees) by heat conduction.

The heating element 200 may include an electrically resistive heater and/or an inductively heated heater.

For example, referring to FIG. 1, the heating element 200 may be a resistive heater. For example, the heating element 200 includes an electrically conductive track, and the heating element 200 may be heated as a current flows through the electrically conductive track. The heating element 200 may be electrically connected to the power source 11. The heating element 200 may be provided with a current from the power source 11 to directly generate heat. The heating element 200 is a hollow heater that is arranged to surround at least a part of a stick S inserted into an insertion space to heat the outside of the inserted stick S, or is a heater in the shape of a needle, rod, tube, etc. that is inserted into the inside of the stick S inserted into the insertion space to heat the inside. The heating element 200 may also be configured in the form of a metal having a predetermined thermal conductivity, a heating film (e.g., a polyimide film), or a separate power source capable of generating heat by itself, but is not limited thereto.

For example, referring to FIG. 2, the aerosol generating device 1 may include an induction coil 201 surrounding the heating element 200. The induction coil 201 may cause the heating element 200 to generate heat. The heating element 200 may be implemented as a ferromagnetic material. The heating element 200 is a susceptor, and the heating element 200 may be heated by a magnetic field generated by an AC current flowing through the induction coil 201. The magnetic field penetrates the heating element 200 and may generate an eddy current in the heating element 200. The current may generate heat in the heating element 200.

On the other hand, a susceptor may be included inside the stick S, and the susceptor inside the stick S may be heated by a magnetic field generated by an AC current flowing through the induction coil 201.

Conventionally, a separate power source is directly applied to the infrared radiator 100 to emit infrared rays. However, when power source is directly applied to an infrared radiator having high conductivity such as a carbon nanotube, a phenomenon such as a heat spot occurs, and heat generation control becomes difficult. When the stick S is externally heated only by the heating element 200 or the stick S is heated by infrared rays generated by applying a separate power source to the infrared radiator 100, a defect in the internal configuration of the aerosol generating device 1 may occur due to a rapid heating phenomenon. In addition, an unpleasant odor may be generated by burning the paper of the stick S at a high temperature.

In the embodiment of the present disclosure, the infrared radiator 100 and the stick S are primarily heated by heat conduction from the adjacent heating element 200 to facilitate heat generation control of the infrared radiator 100. The heating element 200 heated by power source supply heats the infrared radiator 100 through heat conduction. The heat conducted to the infrared radiator 100 is transferred back to the stick S. As a result, both the stick S and the infrared radiator 100 are heated by heat conduction. In this manner, due to the characteristics of the material of the infrared radiator 100, heating may proceed more slowly and stably than directly applying a separate power source to the infrared radiator 100.

As the stick S starts to be heated by the heating element 200 and a predetermined time elapses, the infrared ray radiator 100 heated to a predetermined temperature starts to emit infrared rays. Heat is secondarily applied to the stick S by infrared rays emitted from the heating element 200. Due to the stable heating, the emitted infrared wavelength penetrates deeply into the stick S, so that heating of the tobacco medium contained in the stick S is efficiently performed. In this case, as the temperature around the stick S increases by the heating element 200, the heating by the infrared radiation or the heat conduction process on the infrared radiator may be more efficiently performed.

The power source 11 may supply power to the components of the aerosol generating device 1 to operate. The power source 11 may be referred to as a battery. The power source 11 may supply power to at least one of the control unit 12, the sensor 13, and the heating element 200. The power source 11 may supply power to the induction coil 201.

The control unit 12 may control the overall operation of the aerosol generating device 1. The control unit may comprise at least one processor. The control unit may be mounted on a printed circuit board (PCB). The control unit 12 may control the operation of at least one of the power source 11, the sensor 13, and the heating element 200. The control unit 12 may control the operation of the induction coil 201. The control unit 12 may control an operation of a display, a motor, or the like provided in the aerosol generating device 1. The control unit 12 may check the state of each of the components of the aerosol generating device 1 to determine whether the aerosol generating device is in an operable state.

The control unit 12 may analyze the result sensed by the sensor 13 and control processes to be performed thereafter. For example, the control unit 12 may control the power supplied to the heating element 200 so that the operation of the heating element 200 is started or ended, based on the result sensed by the sensor 13. For example, the control unit 12 may control, based on a result sensed by the sensor 13, the amount of power supplied to the heating element 200 and the time at which the power is supplied so that the heating element 200 may be heated to a predetermined temperature or maintain an appropriate temperature.

The sensor 13 may include at least one of a temperature sensor, a puff sensor, an insertion detection sensor, and an acceleration sensor. For example, the sensor 13 may sense at least one of a temperature of the stick S, a temperature of the infrared radiator 100, a temperature of a heating element 200, a temperature of a power source 11, and a temperature inside and outside the body 10. For example, the sensor 13 may sense a user's puff. For example, the sensor 13 may sense whether the stick S is inserted into the insertion space. For example, the sensor 13 may sense movement of the aerosol generating device 1.

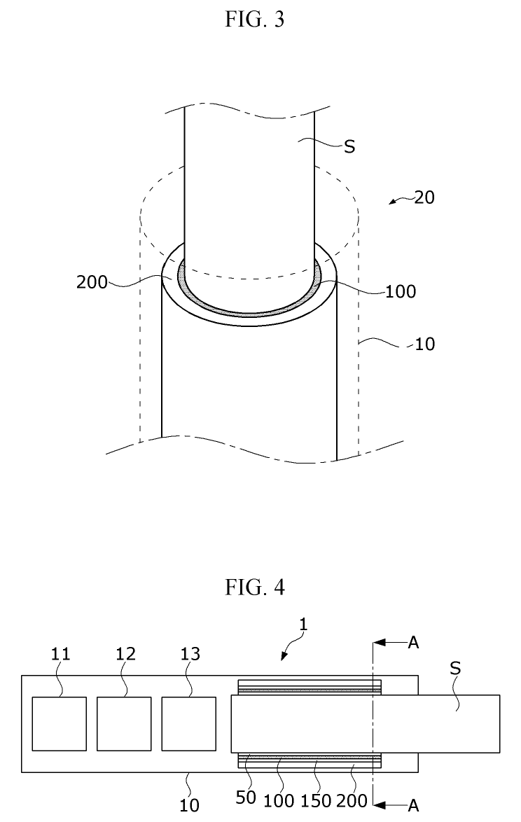

FIG. 3 is a diagram illustrating a stick heating structure 20 according to an embodiment of the present disclosure.

The stick heating structure 20 may refer to a structure including at least one configuration of the stick S, the infrared radiator 100, the heating element 200, and the body 10 adjacent thereto in the configuration of the aerosol generating device 1.

In the stick heating structure 20 according to an embodiment, the infrared radiator 100 may be positioned to be in direct contact with at least a part of the stick S inserted into the insertion space. In addition, the infrared radiator 100 may be positioned to be in direct contact with at least a part of the heating element 200. The infrared radiator 100 and the heating element 200 may be positioned in order from the center of the stick S toward the outside.

In the stick heating structure 20 of FIG. 3, the stick S, the infrared radiator 100, and the heating element 200 may be in contact with each other without a gap. The infrared radiator 100 is supplied with a heat source only through the heating element 200 without a separate power source connection. The infrared radiator 100 becomes an intermediate layer between the stick S and the heating element 200 in contact without a gap, and may transfer heat generated by the heating element 200 to the stick S in a thermally conductive manner. In addition, infrared rays are emitted from the infrared radiator 100 heated to some extent, and the emitted infrared rays additionally heat the stick S.

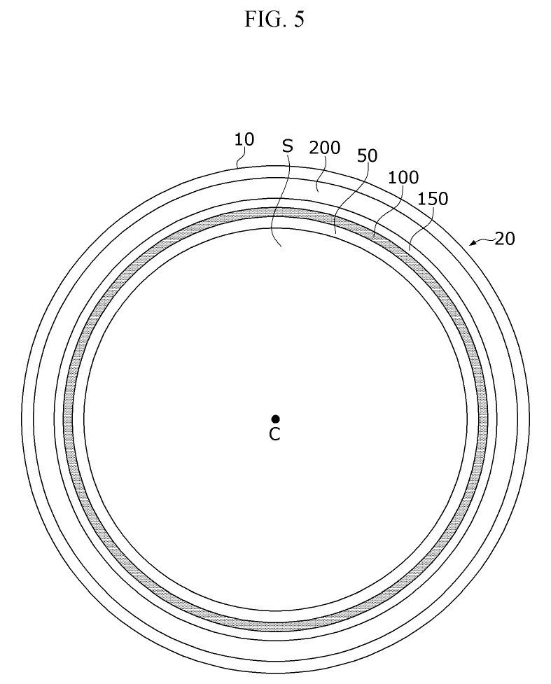

FIG. 4 is a diagram illustrating an aerosol generating device 1 including a stick heating structure 20 according to another embodiment of the present disclosure. For a description of FIG. 4, refer to FIG. 5. FIG. 5 is a cross-sectional view of the stick heating structure 20 as viewed in the direction A of FIG. 4.

The stick heating structure 20 may include configurations having different diameters based on the midpoint C of the stick S. The configurations may include at least a part of one area of a coating layer 50, the infrared radiator 100, an adhesive layer 150, the heating element 200, and the body 10. The coating layer 50, the infrared radiator 100, the adhesive layer 150, and the heating element 200 may be formed to have greater and greater diameters in the outer direction of the stick S. For example, based on the midpoint C of the stick S, the infrared radiator 100 may have a greater diameter than the stick S, and the heating element 200 may have a greater diameter than the infrared radiator 100.

According to an embodiment, a coating layer 50 may be formed between the stick S and the infrared radiator 100. The coating layer 50 has a function of increasing the durability of the infrared radiator 100 and allowing the heating of the stick S to proceed more stably. The coating layer 50 may wrap inward around the stick S and contact the infrared radiator 100 outwardly.

According to an embodiment, the coating layer 50 may be made of a material having a transparency of a predetermined degree or more so as not to interfere with the emission of infrared rays. For example, the coating layer 50 may be made of a material such as quartz, sapphire, ceramic, or alumina, but is not limited thereto. The coating layer 50 may be implemented in such a manner that it is in contact with the stick S and the infrared radiator 100, respectively, at least in part. The coating layer 50 may be configured in the form of a thin film coated on the infrared radiator 100.

According to an embodiment, an adhesive layer 150 for bonding the infrared radiator 100 and the heating element 200 may be formed between the infrared radiator 100 and the heating element 200. The adhesive layer 150 may wrap inward around the infrared radiator 100 and contact the heating element 200 outwardly.

According to an embodiment, the adhesive layer 150 may be formed to have a relatively small thickness for thermal conduction. For example, the adhesive layer 150 may be configured in the form of a thin film or a material for adhesion may be applied. The adhesive layer 150 may be implemented in such a manner that it is in contact with the infrared radiator 100 and the heating element 200, respectively, at least in part.

On the other hand, the coating layer 50 and the adhesive layer 150 are included in the case where the heating element 200 is implemented as an electrically resistive heater in FIG. 4, but the present invention is not limited thereto, and may also be applied to the case where the heating element 200 is implemented as the inductively heated heater as shown in FIG. 2. In this case, an induction coil 201 may be additionally formed inside the body 10 to the outside of the heating element 200.

As described above, through the structure of FIGS. 4 and 5, heating by a heat conduction method and heating by infrared radiation may be more effectively performed. The thicknesses of the respective configurations disclosed in FIGS. 4 and 5 are optionally illustrated for convenience of description, and the thicknesses of these configurations may be variously implemented.

On the other hand, according to an embodiment, at least one of the infrared radiator 100 and the heating element 200 may be configured as a detachable module, for example, a detachable stick heating structure, so as to be detachable from the aerosol generating device 1. According to various embodiments, the detachable stick heating structure may further include at least one of the coating layer 50 and the adhesive layer 150 mentioned in FIGS. 4 and 5.

According to various embodiments, the detachable detachable stick heating structure may be designed to be replaceable without disassembling with a separate tool. To this end, the configurations comprised in the detachable stick heating structure may be implemented so as not to be electrically or physically connected with the configurations inside the aerosol forming device 1.

According to various embodiments, the detachable stick heating structure may include a frame that physically supports at least one of the coating layer 50, the infrared radiator 100, the adhesive layer 150, and the heating element 200. In addition, at least a partial area of the frame may be opened to communicate with the insertion space of the aerosol generating device 1.

As described above, as the stick heating structure is configured as a detachable module, unnecessary internal configuration for fixing the stick heating structure or cumbersome cleaning process with stick residue may be omitted.

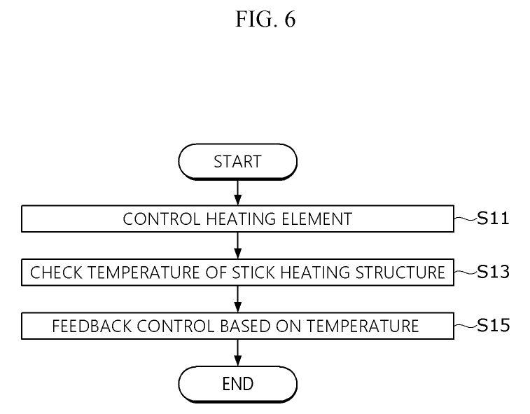

FIG. 6 is a flowchart illustrating temperature feedback control according to an embodiment of the present disclosure. At least some of the respective steps in FIG. 6 may be omitted or the mutual order may be changed, and the respective steps may be performed by the aerosol generating device 1 or the control unit 12.

The control unit 12 may control the heating element 200 (S11). For example, the control unit 12 may control a power source applied to the heating element 200 by controlling the amount of current transmitted from the power source 11 to the heating element 200.

The control unit 12 may check the temperature of the stick heating structure 20 (S13). According to an embodiment, the control unit 12 may collect temperature data on at least one of the stick S, the infrared radiator 100, the heating element 200, or any area inside the aerosol generating device 1 through the sensor 13.

The control unit 12 may control a power source applied to the heating element 200 based on the collected temperature data (S15).

For example, when the temperature of the infrared radiator 100 has not reached an appropriate temperature for emitting infrared rays at any point in time, the control unit 12 may increase the amount of current applied from the power source 11 to the heating element 200 or the induction coil 201. An appropriate temperature for emitting infrared light may be preset, for example, to a first threshold value. The first threshold value may be stored in the memory in advance according to a material characteristic of the infrared radiator 100 or the like.

For example, when the infrared ray emitted from the infrared ray radiator 100 is excessive, the control unit 12 may reduce the amount of current applied to the heating element 200. The temperature value in the case of excessive emission of infrared rays may be experimentally preset to a second threshold value. When the temperature of the infrared radiator 100 is determined to be equal to or higher than the second threshold value at any point in time, the control unit 12 may reduce the amount of current applied to the heating element 200 or the induction coil 201. This second threshold value may be set to a value higher than the first threshold value.

On the other hand, the first threshold value and the second threshold value are not limited to the temperature of the infrared radiator 100, and may be set as the temperature of the stick S and the heating element 200.

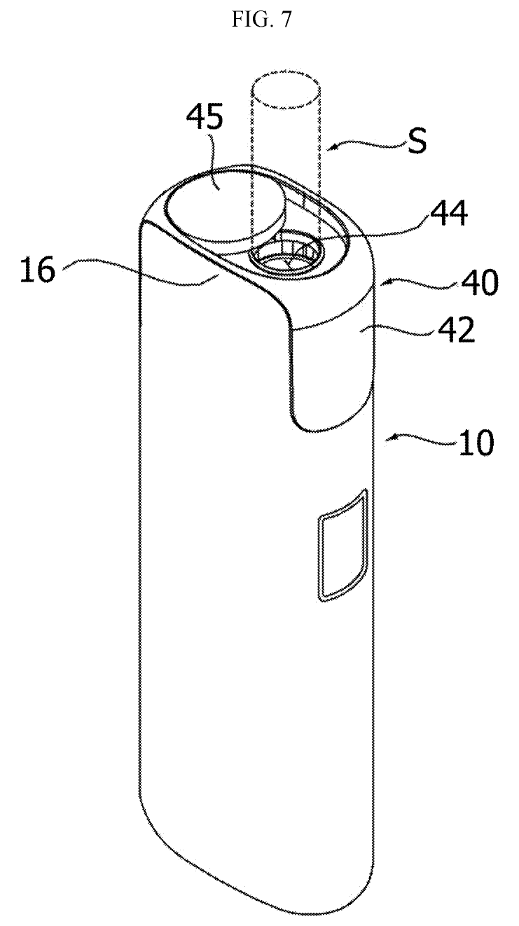

FIG. 7 is a front perspective view of an aerosol generating device 1 according to embodiments of the present disclosure.

Referring to FIG. 7, an upper case 40 may be releasably coupled to the body 10. The upper case 40 may be coupled to an upper side of the body 10. The upper case 40 may cover the upper periphery of the body 10. The upper case 40 may include an insertion opening 44. The stick S may be inserted into the insertion opening 44. The upper case 40 may include a cap 45 that opens and closes the insertion opening 44. The cap 45 may be slid laterally to open and close the insertion opening 44.

The upper case 40 may include an upper case wing 42. The upper case wing 42 may extend downwardly from either side of the upper case body. The upper case wings 42 may be referred to as an upper case grip 42.

The body 10 may include a body wing 16. The body wing 16 may extend upwardly from an upper edge of the body 10. The body wings 16 may be formed in a pair that is opposed about the top of the body 10. The body wing 16 may be formed at a position displaced from the upper case wing 42.

When the upper case 40 is coupled to the body 10, the upper case 40 may form an upper appearance of the aerosol generating device 1. When the upper case 40 is coupled to the body 10, the body wings 16 may cover the side portions of the upper case 40 exposed between the upper case wings 42. When the upper case 40 is coupled to the body 10, the upper case wing 42 may cover an outer wall of the body 10.

The term ‘unit’ used in this embodiment means software or hardware components such as a field-programmable gate array (FPGA) or an ASIC, and the ‘unit’ performs certain roles. However, “unit” is not limited to software or hardware. The ‘unit’ may be configured to be in an addressable storage medium and may be configured to play back one or more processors. Thus, by way of example, ‘unit’ includes components such as software components, object-oriented software components, class components and task components, processes, functions, attributes, procedures, subroutines, segments of program code, drivers, firmware, microcode, circuitry, data, database, data structures, tables, arrays, and variables. The functionality provided within the components and ‘unit’s may be combined into a smaller number of components and ‘unit’s or further separated into additional components and ‘unit’s. In addition, the components and ‘unit’s may be implemented to play back one or more CPUs in a device or secure multimedia card.

While the foregoing has been described with reference to preferred embodiments of the invention, it will be appreciated that those skilled in the art will be able to make various modifications and changes to the invention without departing from the spirit and scope of the invention as set forth in the following claims.

What is claimed is:

1. An aerosol generating device, comprising:
a body (10) including an insertion space opened to allow insertion of at least a part of a stick (S);
an infrared radiator (100) configured to emit infrared rays to heat the stick (S); and
a quartz layer (50) formed between the stick (S) and the infrared radiator (100).

2. The device of claim 1, wherein quartz layer (50) is made of quartz having a transparency of a predetermined degree or more so as not to interfere with the emission of infrared rays.

3. The device according to claim 1, further comprising:
a heating element (200) to conduct heat to the infrared radiator (100); and
a control unit (12) configured to apply a power source (11) to the heating element (200).

4. The device of claim 3, wherein the heating element (200) is configured to be inserted into the inside of the stick (S) when the stick (S) is inserted into the insertion space (200) to heat the inside.

5. A method of operating an aerosol-generating device, comprising:
emitting infrared rays from an infrared radiator (100) to a stick (S) inserted into an insertion space of the aerosol generating device;
passing the infrared rays through a quartz layer (50) disposed between the infrared radiator (100) and the stick (S); and
heating the stick (S) by the infrared rays having passed through the quartz layer (50).

6. The method of claim 5, further comprising:
supplying power to a heating element (200); and
providing heat to the infrared radiator (100) through the heating element (200) so that the infrared radiator (100) emits infrared rays.

7. The method of claim 6, wherein the heating element (200) is inserted into the inside of the stick when the stick (S) is inserted into the insertion space to heat the inside of the stick.
